(19) United States
(12) Patent Application Publication
(10) Pub. No.: US 2014/0245286 A1
(43) Pub. Date: Aug. 28, 2014

(54) APPLICATION MANAGING SYSTEM AND METHOD USING SAME

(71) Applicants: HON HAI PRECISION INDUSTRY CO., LTD., New Taipei (TW); Fu Tai Hua Industry (Shenzhen) Co., Ltd., Shenzhen (CN)

(72) Inventors: SHIH-FANG WONG, New Taipei (TW); XIN LU, Shenzhen (CN); FEI WANG, Shenzhen (CN); DAN CAO, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 14/190,139

(22) Filed: Feb. 26, 2014

(30) Foreign Application Priority Data
Feb. 28, 2013 (CN) 2013100635240

(51) Int. Cl. G06F 9/445

(52) U.S. Cl. CPC G06F 8/62
USPC 717/174

(57) ABSTRACT

A system and method used in an electronic apparatus for managing a number of applications installed in the electronic apparatus. The application managing system includes a detection module and an uninstall module. The detection module detects usage states of each application at every predetermined time period and determines unused application(s) in the predetermined time period according to the usage states of the applications. The uninstall module uninstalls the unused application(s). The usage states of each application include times the application was used in the predetermined time period and/or a last time the application was activated in the predetermined time period.

### TECHNICAL FIELD

The disclosure generally relates to application managing technologies, and particularly to an application managing system and method for an electronic device.

### DESCRIPTION OF RELATED ART

Many users download and install applications on their electronic device. However, some applications are rarely, or even never, used but still take a lot of storage space of the electronic device. The users usually need to manually remove these seldom used applications, which are inconvenient and lead to a low efficiency.

Therefore, it is desirable to provide a means which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic apparatus including an application managing system.

FIG. 2 is a schematic view of an interface of reminding a user to select the application to be uninstalled before the application managing system of FIG. 1 uninstalls the application.

FIG. 3 is a flowchart of one embodiment of an application managing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

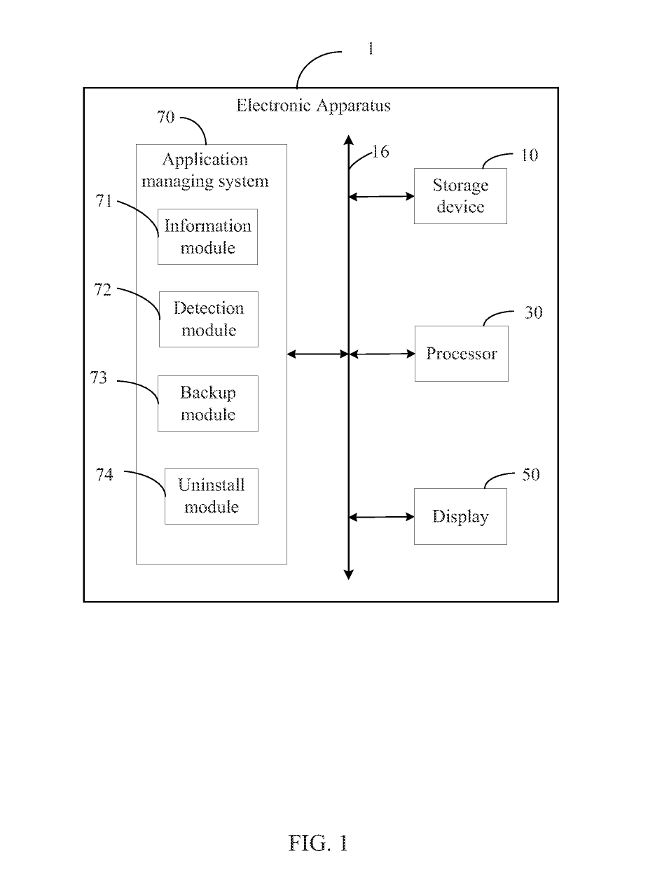

FIG. 1 is a block diagram of one embodiment of an electronic apparatus 1 including an application managing system 70. The application managing system 70 is used to manage a number of applications installed in the electronic device 1. The electronic device 1 may be, but is not limited to, a smart phone, a mobile internet device (MID), an electronic book, or a portable game machine.

The electronic apparatus 1 includes a display 50, a storage device 10, and a processor 30. The application managing system 70 is stored in the storage device 10 and executed by the processor 30. The display 50, the storage device 10, the processor 30, and the application managing system 70 are directly or indirectly electrically connected via a bus 16 for exchange of data or control signals.

The application managing system 70 includes an information module 71, a detection module 72, a backup module 73, and an uninstall module 74. These modules 71-74 of the application managing system 70 may be embedded in an operation system of the electronic apparatus 1, or stored in the storage device 10 and executed by the processor 30.

The information module 71 records basic information of the application installed in the storage device 10 when the application is installed in the electronic device 1. In this embodiment, the basic information of the application includes an application name, an application version, a download address, and a storage path.

The detection module 72 detects usage states of each application installed in the electronic device 1 at every predetermined time period, such as 15 days or 30 days. The detection module 72 determines unused application(s) according to the usage state of the application. The usage states of the application include times each application is used and/or a last time each application was activated in the predetermined time period. In detail, the detection module 72 records every time each application was activated in the predetermined time period, and then counts the number of times the application was activated to acquire the times the application is used in the predetermined time period.

In a first embodiment, the detection module 72 determines the application as the unused application when the application is used less than or equal to a preset number of times.

In a second embodiment, the detection module 72 determines the application as the unused application when a time interval between the last time the application was activated and a current time is greater than a preset time period, such as 7 days.

In a third embodiment, the detection module 72 determines the application as the unused application when the application is used less than the preset number of times and the time interval between the last time of the application was used and the current time is greater than the preset time period.

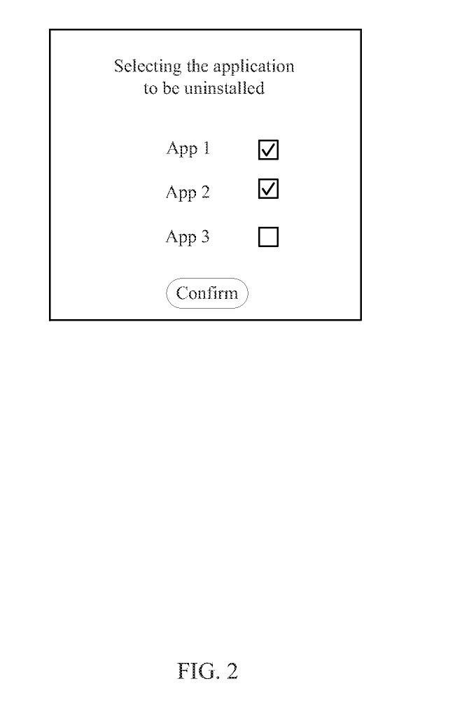

The uninstall module 74 uninstalls the unused applications determined by the detection module 72. In detail, FIG. 2 shows that the uninstall module 74 displays a box including icon(s) correspondingly representing all of the unused application(s) via the display 50 to remind the user to select the application(s) to be uninstalled from the unused application(s) determined by the detection module 72. Then, the uninstall module 74 uninstalls the applications selected by the user and informs the user when the selected applications have been uninstalled by displaying a preset text or giving out an audio alarm. In the other embodiments, the uninstall module 74 directly uninstalls all of the unused applications without the selection of the user.

The backup module 73 backs up the basic information of the applications uninstalled by the uninstall module 74 in an assigned area of the storage device 10, such as a folder named “uninstall backup” preset in the storage device 10. Thus, the user can quickly download and install the uninstalled application again when they want to use the uninstalled application. The basic information of the application is recorded in the storage device 10 by the information module 71.

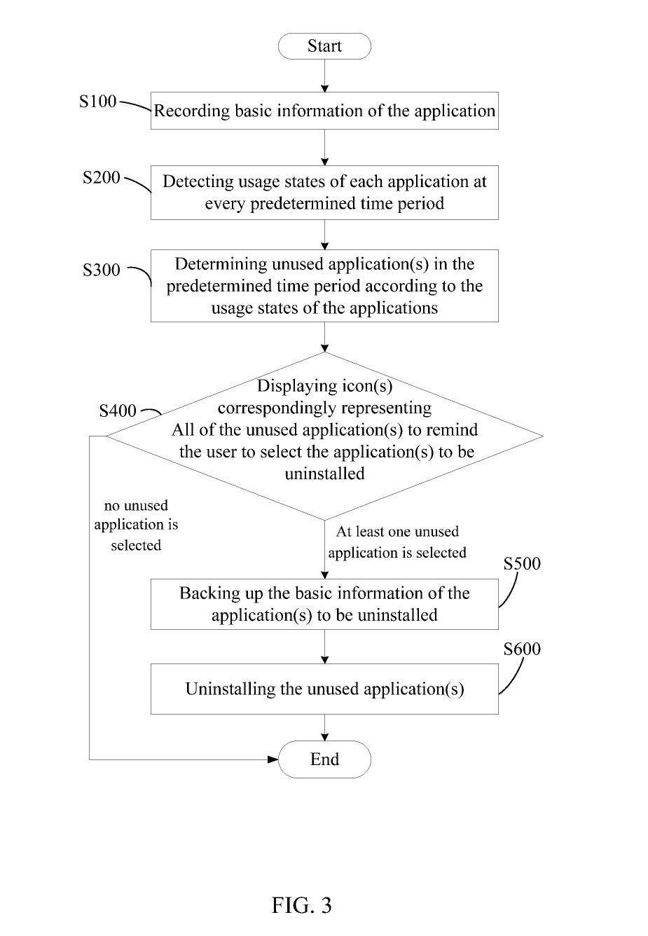

FIG. 3 is a flowchart of an embodiment of an application managing method. Depending on the embodiment, additional steps may be added, others deleted, and the ordering of the steps may be changed.

In step S100, the information module 71 records the basic information of the application in the storage device 10 when the application is installed in the electronic apparatus 1.

In step S200, the detection module 72 detects the usage states of each application installed in the electronic device 1 at every predetermined time period.

In step S300, the detection module 72 determines the unused applications according to the usage states of each application in the predetermined period detected by the detection module 72.

In step S400, the uninstall module 74 displays icon(s) correspondingly representing all of the unused application(s) via the display 50 to remind the user to select the application(s) to be uninstalled from the unused application(s) determined by the detection module 72. The uninstall module 74 ends the process when there is no unused application selected by the user.

In step S500, when there is at least one unused application selected by the user, the backup module 73 backs up the basic information of the application(s) selected by the user in an assigned area of the storage device 10, such as a folder named “uninstall backup” preset in the storage device 10. In detail, the basic information of the application includes an application name, an application version, a download address, and a storage path.

In step S600, the uninstall module 74 uninstalls the unused application(s) selected by the user and informs the user when the selected applications have been uninstalled by displaying a preset text or giving out an audio alarm.

The application managing system 70 and method automatically detects the unused application(s) and uninstalls the unused application(s) according to a manual selection, which saves the storing space of the storage device 10 and improves efficiency of managing the applications of the electronic apparatus 1.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An application managing system of an electronic apparatus, the electronic apparatus installing a number of applications, the application managing system comprising:
a detection module that detects usage states of each application at every predetermined time period and determines unused application(s) in the predetermined time period according to the usage states of the applications; and
an uninstall module that uninstalls the unused application(s);
wherein the usage states of each application detected by the detection module comprises times each application is used in the predetermined time period and/or a last time each application was activated in the predetermined time period.

2. The application managing system of claim 1, wherein the uninstall module displays a box comprising icon(s) correspondingly representing all of the unused application(s) to remind a user to select application(s) to be uninstalled from the unused application(s) determined by the detection module.

3. The application managing system of claim 1, further comprising an information module that records basic information of the application in a storage device of the electronic apparatus, wherein the basic information of the application comprises an application name, an application version, a download address, and a storage path.

4. The application managing system of claim 3, further comprising a backup module that backs up the basic information of the applications uninstalled by the uninstall module in an assigned area of the storage device.

5. The application managing system of claim 1, wherein the usage states of the application comprises times each application is used in the predetermined time period, the detection module records every time each application was activated in the predetermined time period, and then counts the number of times the application is activated to acquire the times the application is used in the predetermined time period.

6. The application managing system of claim 5, wherein the detection module determines the application as the unused application when the application is used less than or equal to a preset number of times.

7. The application managing system of claim 1, wherein the usage states of the application comprises a last time the application was activated in the predetermined time period.

8. The application managing system of claim 7, wherein the detection module determines the application as the unused application when a time interval between the last time the application was activated and a current time is greater than a preset time period.

9. The application managing system of claim 1, wherein the usage states of the application comprises times the application is used and a last time the application was activated in the predetermined time period, and the detection module determines the application as the unused application when the application is used less than or equal to a preset number of times and a time interval between the last time the application was activated and a current time is greater than a preset time period.

10. A application managing method for managing a number of applications installed in an electronic apparatus, the method comprising:
detecting usage states of each application at every predetermined time period;
determining unused application(s) in the predetermined time period according to the usage states of the applications; and
uninstalling the unused application(s);
wherein the usage states of each application detected by the detection module comprises times the application was used in the predetermined time period and/or a last time the application was activated in the predetermined time period.

11. The method of claim 10, further comprising:
displaying icon(s) correspondingly representing all of the unused application(s) to remind the user to select the application(s) to be uninstalled from the unused application(s) before uninstalling the unused application(s).

12. The method of claim 10, further comprising:
recording basic information of the application in a storage device of the electronic apparatus when the application is installed in the electronic apparatus;
wherein the basic information of the application comprises an application name, an application version, a download address, and a storage path.

13. The method of claim 12, further comprising:
backing up the basic information of the application(s) to be uninstalled in an assigned area of the storage device before uninstalling the unused application(s).

14. The method of claim 10, wherein the usage states of the application comprises times the application was used in the predetermined time period, the detection module records every time each application was activated in the predetermined time period, and then counts the number of times the application was activated to acquire the times the application was used in the predetermined time period.

15. The method of claim 14, wherein the detection module determines the application as the unused application when the application is used less than or equal to a preset number of times.

16. The method of claim 10, wherein the usage states of the application comprises a last time the application was activated in the predetermined time period.

17. The method of claim 16, wherein the application is determined as the unused application when a time interval between the last time the application was activated and a current time is greater than a preset time period.

18. The method of claim 10, wherein the usage states of the application comprises times the application is used and a last time the application was activated in the predetermined time period, and the application is determined as the unused application when the application is used less than or equal to a preset number of times and a time interval between the last time the application was activated and a current time is greater than a preset time period.
